(19) United States
(12) Patent Application Publication
(10) Pub. No.: US 2022/0126123 A1
(43) Pub. Date: Apr. 28, 2022

(54) Portable Re-Breathing Apparatus for Disaster

(71) Applicant: DANIEL CO., LTD., Gyeongju-si (KR)

(72) Inventors: Jun Ho Lee, Seoul (KR); Sang Yup Kwon, Ulsan (KR); Jung Han Baek, Ulsan (KR); Chun Sik Choi, Gyeongju-si (KR); Kyung Il Kang, Seogwipo-si (KR)

(21) Appl. No.: 17/507,163

(22) Filed: Oct. 21, 2021

(30) Foreign Application Priority Data
Oct. 28, 2020 (KR) 10-2020-0140923
Oct. 7, 2021 (KR) 10-2021-0133248

(51) Int. Cl. A62B 7/02; A62B 9/02; A62B 9/00

(52) U.S. Cl. CPC A62B 7/02; A62B 7/10; A62B 9/006; A62B 9/02

(57) ABSTRACT

A portable re-breathing apparatus is proposed. the portable re-breathing apparatus includes a mask configured to be worn on face of a user to correspond to mouth thereof and connected to a main hose through which air flows, a first oxygen mixing part connected to the main hose and through which exhalation flows, a second oxygen mixing part (200) configured to remove carbon dioxide (CO2) in the exhalation and to provide oxygen to the mask through the main hose, an air movement part connecting the first oxygen mixing part to the second oxygen mixing part (200), an oxygen supply unit including an oxygen container compress-storing oxygen and configured to supply oxygen to the second oxygen mixing part (200), and a controller (500) connected to the first and second oxygen mixing parts and the oxygen supply unit and configured to regulate CO2 and oxygen density to allow the user to breath.

### CROSS REFERENCE TO RELATED APPLICATION

This application is based on and claims priority from Korean Patent Applications Nos. 10-2020-0140923 filed on Oct. 28, 2020 and 10-2021-0133248 filed on Oct. 7, 2021 in the Korean Intellectual Property Office, the disclosure of which is incorporated herein in its entirety by reference.

### BACKGROUND OF THE INVENTION

### Field of the Invention

The disclosure relates to a portable re-breathing apparatus.

### Description of the Related Art

Unless otherwise indicated herein, contents described in this identification are not prior art to the claims of this application, and the description in this identification is not admitted to be prior art.

In a disaster, heat, flame, and toxic gas are generated and thus put people in danger. It is known that two to five minutes after a fire occurs, people suffocate from the toxic gas and smoke.

An air respirator is used to protect people from these dangers. The air respirator is worn by workers in industrial sites or oxygen-deficient places such as dusty sites, nuclear power plant accident sites, and sites with toxic gases, and by lifeguards (firefighters) at sites where a fire occurs, such as in subways, etc. The face may be protected and inhalation of toxic gases harmful for humans may be prevented by wearing the air respirator.

As in the recent nuclear accident in Japan, in order to prevent exposure radiation of workers working at the nuclear power plant decommissioning site, there is a demand for an air respirator that has a long use time, is light in weight and has a small volume. However, the conventional air respirator has a short use time and is heavy and bulky.

Furthermore, when a worker does not know he or she has a limited supply of oxygen, the life of the worker may be at risk, and it is necessary to prevent the above problem.

### Documents of Related Art

(Patent Document 1) Korean Patent No. 10-2014513 (2019 Aug. 26)

### SUMMARY OF THE INVENTION

Accordingly, the present disclosure has been made keeping in mind the above problems occurring in the related art, and the present disclosure is intended to provide a portable re-breathing apparatus, the portable re-breathing apparatus being configured such that, in an emergency situation such as a work site of nuclear power plant decommissioning or firefighting, to use closed breathing using exhalation, to increase use time and reduce the weight and volume thereof through easy replacement of an oxygen container, to adopt IoT technology so that a manager can check the status of a worker in real time, and to enable a safe work by two way communication.

In addition, the objective of the present disclosure is not limited to the objective described above, and it is obvious that other objectives can be achieved from the following description.

In order to achieve the above objectives, according to one aspect of the present disclosure, there is provided a portable re-breathing apparatus for a disaster, the portable re-breathing apparatus including: a mask configured to be worn on face of a user to correspond to mouth thereof and connected to a main hose through which air may flow; a first oxygen mixing part connected to the main hose and through which exhalation may flow; a second oxygen mixing part configured to remove carbon dioxide (CO2) in the exhalation and to provide oxygen to the mask through the main hose; an air movement part connecting the first oxygen mixing part to the second oxygen mixing part; an oxygen supply unit including an oxygen container compress-storing oxygen and configured to supply oxygen to the second oxygen mixing part; and a controller connected to the first and second oxygen mixing parts and the oxygen supply unit and configured to regulate CO2 and oxygen density to allow the user to breath.

An inhalation hose may be connected to a first portion of the mask and an exhalation hose may be connected to a second portion thereof.

The oxygen supply unit may include: an oxygen supply hose connected to the second oxygen mixing part; and an oxygen container connecting part mounted to the oxygen supply hose, wherein the oxygen container may be removably connected to the oxygen container connecting part and configured to be replaceable.

The portable re-breathing apparatus may include: a casing part to which the first oxygen mixing part or the second oxygen mixing part may be mounted, and configured to be worn on back of the user; and a wearing part consisting of a strap connected to the casing part and slung on shoulder.

The oxygen supply hose may include a plurality of oxygen supply hoses to be respectively arranged on opposite shoulders, a storage tank provided in the casing part having inlets divided from the storage tank toward opposite sides, and the oxygen supply hoses may be respectively connected to the inlets, and a hose connected to an outlet of the storage tank may be connected to the controller, and be connected to the second oxygen mixing part while passing through the controller.

The first oxygen mixing part may include a sensor configured to detect oxygen, CO2, pressure, and temperature.

The second oxygen mixing part may include a filter configured to remove CO2 and to be replaceable.

The second oxygen mixing part may include an oxygen density regulator configured to regulate density of oxygen supplied from the oxygen supply unit.

The oxygen density regulator may include: a first oxygen supply regulator configured to oxygen supplied to the second oxygen mixing part by being automatically operated when the controller is operated and power is supplied; and a second oxygen supply regulator configured to supply oxygen to the second oxygen mixing part by being operated when the first oxygen supply regulator is not operated due to non-operation of the controller or no-supply of power.

The oxygen supply unit may further include a pressure regulator configured to reduce the pressure of oxygen discharged from the oxygen container.

The oxygen container and the pressure regulator may be removably coupled to each other, so that a used oxygen container may be replaceable.

The oxygen container may include: a supply hole provided at an upper portion of the oxygen container and configured to communicate with the pressure regulator; a screw thread part located on an upper outer circumferential surface of the oxygen container; a first cap inserted-coupled to the supply hole and having a hole configured to communicate with the supply hole; a second cap coupled to the first cap and having a hole configured to communicate with the supply hole; and a screw coupling part having a hole located on an upper portion thereof and configured to communicate with the supply hole, and having screw threads on inner and outer circumferential surfaces thereof, wherein the screw coupling part may be coupled to the screw thread part.

The pressure regulator may have a screw thread on a lower inner circumferential surface thereof, the screw thread being coupled to the screw coupling part, and the screw coupling part of the oxygen container may be removably screwed-coupled to the pressure regulator.

The first cap may have a shape of which a center portion may be convex downward, the first cap including an elastic material, and the second cap may have a shape of which a center portion may be convex downward to correspond to the shape of the first cap.

The portable re-breathing apparatus may include: a T-shaped connector having three holes, wherein the T-shaped connector may include: a first connector having a first hole and coupled to the main hose; a second connector having a second hole and coupled to the first oxygen mixing part; and a third connector having a third hole and coupled to the second oxygen mixing part, wherein the connector may be configured such that the second hole may be closed during inhalation and the third hole may be closed during exhalation.

The controller may be automatically operated by an artificial intelligence operated by a bio-sensor, and may include an automatic emergency call function, three information sharing channels, an IoT network wireless communication module, and a high-capacity internal rechargeable battery.

According to the present disclosure, closed breathing using exhalation is possible and a replaceable oxygen container storing compressed oxygen is provided. Therefore, the use time of the portable re-breathing apparatus can be increased and the weight and volume of the portable re-breathing apparatus can be reduced.

Even when inflow of outside air is prevented, the portable re-breathing apparatus appropriately mixes oxygen with exhalation generated by breathing to enable a user to breathe. Therefore, spontaneous breathing is possible for a long time, and the safety of the user can be guaranteed in an extreme environment and work efficiency can be improved.

Even when there is a problem with the electronic control, oxygen can be supplied to the second oxygen mixing part by using the second oxygen supply regulator.

The oxygen container is screwed-coupled to the pressure regulator. Therefore, when all oxygen in the oxygen container is consumed, the user can easily separate a used oxygen container and replace the used oxygen container with a new oxygen container.

The pressure regulator is directly coupled to the oxygen container storing high-pressure oxygen and regulates oxygen from high pressure to low pressure. Therefore, there is no need to use an expensive devices which is capable of withstanding high pressure for the hose connecting the pressure regulator to the second oxygen mixing part, a device such as the oxygen density regulator, etc. that are connected to the portable re-breathing apparatus after pressure reduction, and general devices can be used as the devices connected to the portable re-breathing apparatus after pressure reduction. Accordingly, economic efficiency of and convenience of the user can be improved.

When the pressure regulator is coupled to the oxygen container, there is no need to use the oxygen container connecting part or a manual valve. Therefore, the weight of the portable re-breathing apparatus can be reduced and economic efficiency and convenience of the user can be improved.

The connector is directly connected to the first and second oxygen mixing parts and the single main hose is connected to the mask 20, so that the user can easily and conveniently use the portable re-breathing apparatus.

IoT technology is applied to the portable re-breathing apparatus, so that a manager can check the status of a worker in real time and the worker can safely work by two-way communication.

The effects of the present disclosure are not limited to the above description, and other effects not mentioned will be clearly understood by those skilled in the art from the following description.

### BRIEF DESCRIPTION OF THE DRAWINGS

The above and other objectives, features, and other advantages of the present disclosure will be more clearly understood from the subsequent detailed description when taken in conjunction with the accompanying drawings, in which:

FIG. 1 is a perspective view showing a portable re-breathing apparatus according to a first embodiment of the present disclosure.

FIG. 2 is a rear view showing the portable re-breathing apparatus according to the first embodiment of the present disclosure.

FIG. 3 is a view showing an operation of the portable re-breathing apparatus according to the first embodiment of the present disclosure.

FIG. 4 is a perspective view schematically showing the portable re-breathing apparatus the filter according to the first embodiment of the present disclosure.

FIG. 5 is a perspective view showing a portable re-breathing apparatus according to a second embodiment of the present disclosure.

FIG. 6 is a schematic view showing an oxygen density regulator of the portable re-breathing apparatus according to the second embodiment of the present disclosure.

FIGS. 7A and 7B are a perspective view and an exploded-perspective view showing a pressure regulator of the portable re-breathing apparatus according to the second embodiment of the present disclosure.

FIG. 8 is a perspective view showing an oxygen supply unit of the portable re-breathing apparatus according to the second embodiment of the present disclosure.

FIG. 9 is an exploded-perspective view showing an oxygen container according to the second embodiment of the present disclosure.

FIG. 10 is an enlarged-perspective view showing part A in FIG. 9.

FIG. 11 is an enlarged-perspective view showing part B in FIG. 9.

FIG. 12 is a perspective view showing a connector of the portable re-breathing apparatus according to the second embodiment of the present disclosure.

FIG. 13 is a view showing an operation of the portable re-breathing apparatus according to the second embodiment of the present disclosure.

FIG. 14 is a view showing the portable re-breathing apparatus of the present disclosure in conjunction with an external wireless terminal.

### DETAILED DESCRIPTION OF THE INVENTION

Hereinafter, the configuration, operation, and effects of a portable re-breathing apparatus according to an exemplary embodiment of the present disclosure will be described with reference to the accompanying drawings. For reference, in the following drawings, each component is omitted or schematically illustrated for the convenience and clarity of the description of the present disclosure, and the size of each component does not reflect the actual size. Additionally, the same reference numerals refer to the same components throughout the specification, and reference numerals for the same components in individual drawings will be omitted.

Hereinbelow, a portable re-breathing apparatus 900 according to an embodiment of the present disclosure will be described with reference to accompanying drawings.

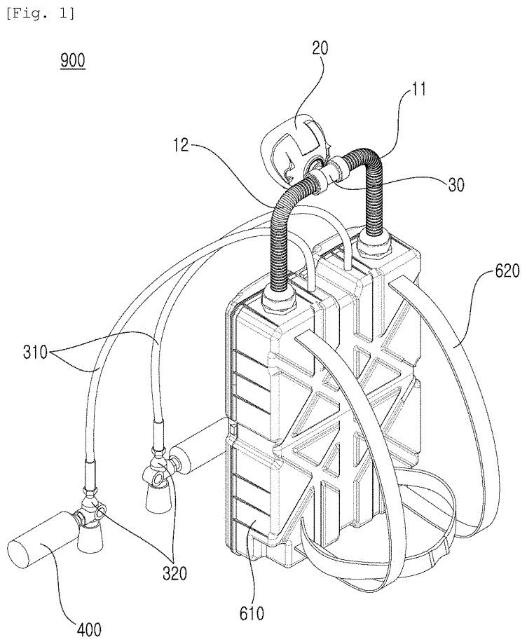

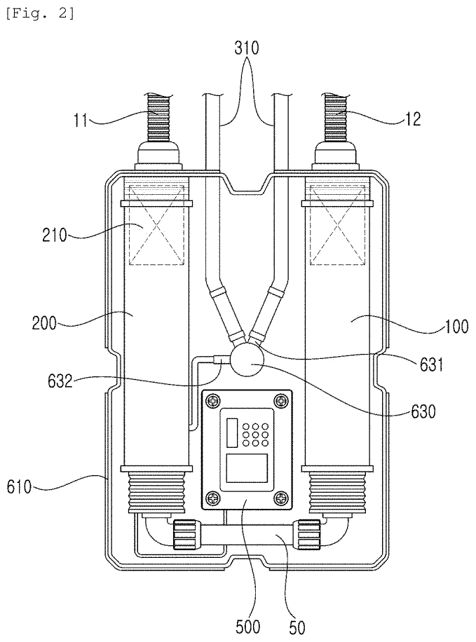

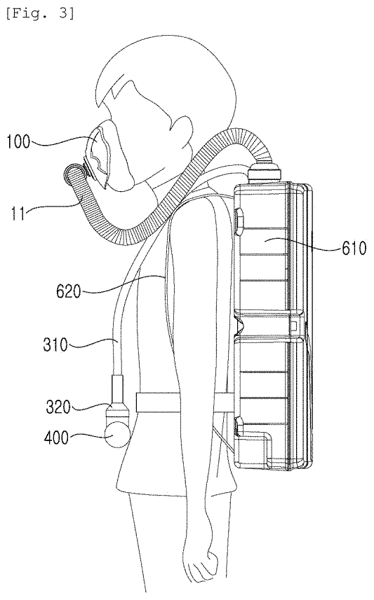

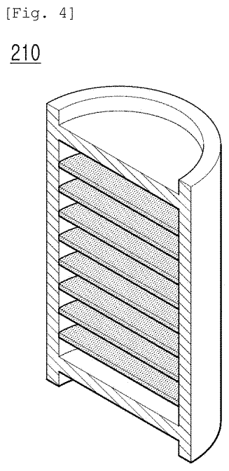

FIG. 1 is a perspective view showing the portable re-breathing apparatus 900 according to a first embodiment of the present disclosure. FIG. 2 is a rear view showing the portable re-breathing apparatus 900 according to the first embodiment of the present disclosure. FIG. 3 is a view showing an operation of the portable re-breathing apparatus 900 according to the first embodiment of the present disclosure. FIG. 4 is a perspective view schematically showing a filter 210 of the portable re-breathing apparatus 900 according to the first embodiment of the present disclosure.

The present disclosure relates to the portable re-breathing apparatus 900. The portable re-breathing apparatus 900 of the present disclosure is configured, in an emergency situation such as a work site of nuclear power plant decommissioning or firefighting, to use closed breathing using exhalation, to increase use time and reduce weight and volume of the portable re-breathing apparatus through easy replacement of an oxygen container 400, to supply oxygen to a second oxygen mixing part 200 by a second oxygen supply regulator 222 even when there is a problem with the electronic control, to adopt IoT technology so that a manager can check the status of a worker in real time, and to enable the worker to safely work by two way communication, whereby safety, convenience, and economy efficiency of the worker may be improved. According to the first embodiment of the present disclosure, the portable re-breathing apparatus 900 may include a main hose 10, a mask 20, first and second oxygen mixing parts 100 and 200, an oxygen supply unit 300, a controller 500, and a connector 700.

According to the present disclosure, the portable re-breathing apparatus 900 may include the mask 20 worn on the face of a user to correspond to the mount and connected to the main hose 10 into which air flows, the first oxygen mixing part 100 connected to the main hose 10 and into which inhalation flows, the second oxygen mixing part 200 removing carbon dioxide (CO2) in inhalation and supplying oxygen to the mask 20 through the main hose 10, an air movement part 50 connecting the first oxygen mixing part 100 to the second oxygen mixing part 200, the oxygen supply unit 300 including the oxygen container 400 compressing and storing oxygen and supplying oxygen to the second oxygen mixing part 200, and the controller 500 connected to the first and second oxygen mixing parts 100 and 200 and the oxygen supply unit 300 and regulating CO2 density and oxygen density so that the user can inhale. The mask 20 may be connected to an inhalation hose 11 at a first side thereof, and be connected to an exhalation hose 12 at a second side thereof.

As shown in FIG. 1 or 3, as an example, the mask 20 may be brought into close contact with the mouth of the user, and the main hose 10 to be described is connected to the mask 20 so that the mask 20 may serve to supply air to the user. As an example, the mask 20 may have a head band at a rear portion thereof. As an example, the main hose 10 may include the inhalation hose 11 and the exhalation hose 12.

As shown in FIG. 1 or 3, the mask 20 may be connected to a respirator 30 of which a first portion is connected to the inhalation hose 11 and a second portion is connected to the exhalation hose 12. As an example, the respirator 30 may be removably coupled to an opening of the mask 20.

As an example, the portable re-breathing apparatus may include a protection cover connected to the mask 20 to be brought into close contact with the entire area of the face, a protective window through which the user can observe the outside with the eyes, and a head band connected to the protection cover to allow the user to wear the portable re-breathing apparatus on the head.

As an example, the inhalation hose 11 and the exhalation hose 12 respectively have corrugated tubular shapes with a diameter of 25 mm and with a diameter of 30 mm. The length of the hose 11, 12 may be flexible between 200 mm and 300 mm, and a material of the hose 11, 12 may be nonflammable fiber reinforced plastics (FRP).

The respirator 30 may include a one-way opening and closing member. The opening and closing member may be opened in inhalation and be closed in exhalation, so that inhalation and exhalation may be separated from each other. The one-way opening and closing member may include an exhalation prevention pad 31 and an exhalation prevention pad 32. The exhalation prevention pad 31 prevents flowing of inhalation into the inhalation hose 11 and the exhalation prevention pad 32 prevents flowing of exhalation into the exhalation hose 12. Therefore, the one-way opening and closing member may allow an exhalation entrance to be closed in inhalation and allow an inhalation entrance to be closed in exhalation, so that exhalation and inhalation are not mixed with each other.

The portable re-breathing apparatus may include a CO2 filter connected to the inhalation hose 11 or the exhalation hose 12 to remove CO2 in inhalation and exhalation. The CO2 filter removes CO2 and moisture, and supplies about 18% of oxygen to an oxygen mixing module after removing 4% of CO2 and moisture generated from exhalation after breathing 22% oxygen.

Medical soda lime is used to remove CO2 and moisture, and moisture generated from breathing is discharged through a moisture discharge valve to prevent a soda lime filter in a CO2 removal device from clotting. Soda lime is a granular material that absorbs CO2 and water. Soda lime is put into a CO2 absorber and contains calcium hydroxide, sodium hydroxide, and silicic anhydride as main ingredients.

The CO2 filter may minimize breathing resistance, be equipped with upper and lower non-woven filters, meet the waterproof and dustproof standards, have an one-touch replaceable coupling structure, maximize the CO2 removal efficiency by the PWM control, and preferably use CO2 filtering chemicals with high reliability.

The oxygen supply unit 300 includes an oxygen supply hose 310 connected to the second oxygen mixing part 200, and an oxygen container connecting part 320 mounted to the oxygen supply hose 310. The oxygen container 400 is removably coupled to the oxygen container connecting part 320 to be replaceable. The portable re-breathing apparatus may include a casing part 610 to which the first oxygen mixing part 100 or the second oxygen mixing part 200 is mounted and configured to be worn on the back of the user, and a wearing part 620 consisting of a strap that is connected to the casing part 610 and slung on the shoulder. The oxygen supply hose 310 may include a plurality of oxygen supply hoses to be arranged on opposite shoulders. A storage tank 630 provided in the casing part 610 may have the inlets 631 divided to opposite sides and the oxygen supply hoses 310 are respectively connected to the inlets 631. The main hose 10 connected to an outlet 632 of the storage tank 630 may be connected to the controller 500 and connected to the second oxygen mixing part 200 through the controller 500.

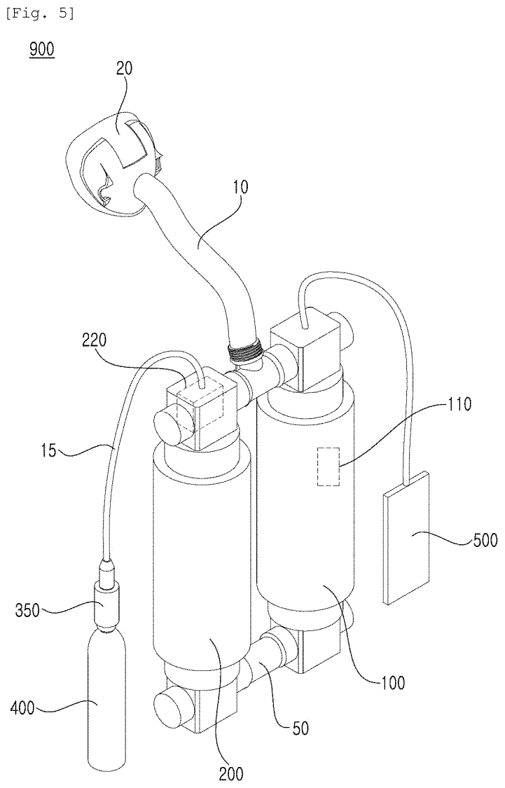

As shown in FIG. 2 or 5, the first oxygen mixing part 100 may be mounted in the casing part 610 and have elasticity to be flexible. The first oxygen mixing part 100 may have a cylindrical enclosure shape having an inlet and an outlet at upper and lower portions and may be connected to the main hose so that exhalation may flow thereinto.

The second oxygen mixing part 200 may be mounted in the casing part 610 and has elasticity to be flexible. The second oxygen mixing part 200 may have a cylindrical enclosure shape having an inlet and an outlet at upper and lower portions thereof, and may be connected to the main hose to supply oxygen to the mask 20 (inhalation).

The air movement part 50 may serve as a path connecting the first oxygen mixing part 100 to the second oxygen mixing part 200, so that the first oxygen mixing part 100 and the second oxygen mixing part 200 communicate with each other.

As shown in FIG. 1 or 2, the oxygen supply unit 300 may serve to supply oxygen to the second oxygen mixing part 200. The oxygen supply unit 300 may include the oxygen supply hoses 310, the oxygen container connecting part 320, the oxygen container 400, and the like.

The oxygen supply hoses 310 may include two oxygen supply hoses to be arranged on the opposite shoulders. A first portion of each of the oxygen supply hoses 310 may be connected to one of the inlets 631 of the storage tank 630, which will be described below, and a second portion thereof may be coupled to the oxygen container connecting part 320, which will be describe below.

As an example, the oxygen container connecting part 320 may be provided at an end of the second portion of the oxygen supply hoses 310. The oxygen container 400 may be coupled to the oxygen container connecting part 320.

The oxygen container 400 compresses and stores oxygen. The oxygen container 400 may be removably coupled to the oxygen container connecting part 320. When all oxygen is consumed, the oxygen container 400 may be separated from the oxygen container connecting part 320 and replaced with a new container.

As an example, the oxygen container 400 may be coupled to the oxygen container connecting part 320 of each of the oxygen supply hoses 310, so that oxygen containers 400 may be mounted to the opposite oxygen supply hoses 310. The oxygen container connecting part 320 may have a regulating handle for regulating an oxygen discharge amount. The oxygen container 400 may be changed with an oxygen container with easy replacement and required capacity when all oxygen is consumed, the oxygen container 400.

The oxygen container 400 may be a high pressure container, and gas in the oxygen container 400 may be made up of 90% oxygen and 10% nitrogen, may have a pressure of 200 bar. A valve provided to the oxygen container 400 may be a diaphragm valve capable of regulating pressure of oxygen discharged from the oxygen container 400.

As shown in FIG. 1, the casing part 610 may be formed in a rectangular box shape, and the first and second oxygen mixing parts 100 and 200 may be mounted thereto. The wearing part 620 may consist of a strap that is coupled to the casing part 610 and slung on the shoulder of the user. The wearing part 620 may be formed such that shoulder straps are provided at opposite portions of one surface of the casing part 610, so that the user can sling the shoulder straps on the shoulders.

As shown in FIG. 2, the storage tank 630 may be provided in the casing part 610 and have the inlets 631 divided from the storage tank to the opposite sides. The oxygen supply hoses 310 may be connected to the inlets 631. A hose connected to the outlet 632 of the storage tank 630 may be connected to the controller 500 and be connected to the second oxygen mixing part 200 through the controller 500.

The hose connected to the outlet 632 of the storage tank 630 may be connected to the controller 500, which will be described below, so that oxygen may be detected by an oxygen sensor of the controller 500.

The controller 500 may be connected to the first and second oxygen mixing parts 100 and 200 and the oxygen supply unit 300. The controller 500 may serve to regulate the oxygen density and the CO2 density to enable the user to breath.

The controller 500 is configured such that a first portion thereof is connected to the first oxygen mixing part 100 and a second portion thereof is connected to the second oxygen mixing part 200 and the oxygen supply hoses 310. The CO2 density and the oxygen density may be regulated to enable the user to breath.

The oxygen mixing part 100, 200 may have an oxygen sensor detecting the oxygen density. The oxygen mixing part 100, 200 may mix oxygen and nitrogen exhaled after breathing therein. Preferably, oxygen may be maintained at 22 v % to be the same as the atmosphere.

Hereinbelow, a portable re-breathing apparatus 900 according to a second embodiment of the present disclosure will be described in detail with reference to accompanying drawings.

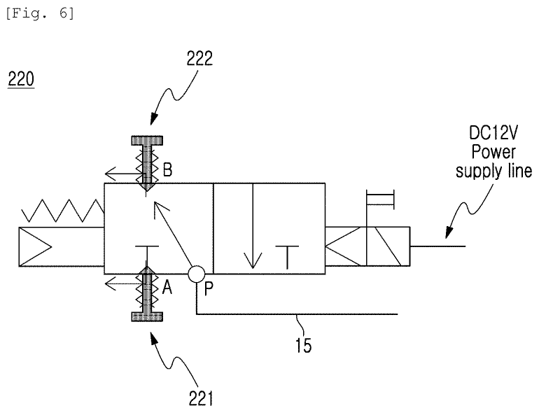

FIG. 5 is a perspective view showing a portable re-breathing apparatus 900 according to a second embodiment of the present disclosure. FIG. 6 is a schematic view showing an oxygen density regulator of the portable re-breathing apparatus according to the second embodiment of the present disclosure.

The first oxygen mixing part 100 may include a sensor 110 detecting oxygen, CO2, pressure, and temperature. The second oxygen mixing part 200 may include the filter 210 removing CO2 and being replaceable, and an oxygen density regulator 220 regulating the density of oxygen supplied from the oxygen supply unit 300. The oxygen density regulator 220 may include a first oxygen supply regulator 221 and the second oxygen supply regulator 222. The first oxygen supply regulator 221 is automatically operated when the controller 500 is operated and power is supplied, and regulates oxygen supplied to the second oxygen mixing part 200. The second oxygen supply regulator 222 is operated when the first oxygen supply regulator 221 is not operated due to non-operation of the controller 500 and no-supply of power, and supplies oxygen to the second oxygen mixing part 200.

The sensor 110 is located in the first oxygen mixing part 100. The sensor 110 may detect oxygen, CO2, pressure, temperature, etc.

As shown in FIG. 4 or 5, the filter 210 is located in the second oxygen mixing part 200, and may serve to remove CO2 in exhalation. A description of the filter is the same as described above.

The oxygen density regulator 220 is arranged in the second oxygen mixing part 200. The oxygen density regulator 220 may serve to regulate the density of oxygen supplied from the oxygen supply unit 300, and include the first and second oxygen supply regulators. As shown in FIG. 5 or 6, the oxygen density regulator 220 may be arranged at an upper portion in the second oxygen mixing part 200, and include an automatic manual-combined solenoid valve.

As shown in FIG. 5 or 6, the first oxygen supply regulator 221 is automatically operated when the controller 500 is operated and power is supplied. The first oxygen supply regulator 221 may serve to regulate oxygen supplied to the second oxygen mixing part 200.

The second oxygen supply regulator 222 is operated in emergency situations when the first oxygen supply regulator 221 is not operated such as when the controller 500 is not operated or power is not supplied. The second oxygen supply regulator 222 may serve to supply oxygen to the second oxygen mixing part 200.

The second oxygen supply regulator 222 is provided to continuously supply oxygen in emergency situations when the electronic control operated by the controller 500 is not possible due to electronic board failure, battery exhaustion, solenoid valve off, etc. The present disclosure relates to human breathing, and is configured to supply oxygen through the electronic control. When electronic board failure, battery exhaustion, etc. occur, oxygen supply stops and causes fatal accidents. Therefore, the present disclosure may mechanically supply oxygen supplies oxygen in normal time even when the electronic control is not possible so as not to interfere with human life.

As shown in FIG. 5 or 6, when oxygen is supplied through a hose 15 connecting the pressure regulator 350 to the second oxygen mixing part 200, oxygen may be supplied to the second oxygen mixing part 200 through one of the first and second oxygen supply regulators 221 and 222. When an electric board is normally operated and the sensor 110 detects that oxygen supply is not sufficient, the first oxygen supply regulator 221 may be opened by the electronic control and oxygen necessary for breathing may be supplied intermittently, at the required density of oxygen. At this time, the second oxygen supply regulator 222 is closed. The first oxygen supply regulator 221 and the second oxygen supply regulator 222 are operated in reverse of each other (when the first oxygen supply regulator 221 is in on, the second oxygen supply regulator 222 is in off, and conversely, when the first oxygen supply regulator 221 is in off, the second oxygen supply regulator 222 is in on). As shown in FIG. 6, the first and second oxygen supply regulators 221 and 222 are coupled to the conventional solenoid valve to regulate an oxygen discharge amount when oxygen flowing into an inlet (P porter) of the solenoid valve is discharged to outlets (A porter and B porter) of the solenoid valve. The first and second oxygen supply regulators 221 and 222 may be formed in a screw thread shape. When the oxygen supply regulator is turned clockwise, the oxygen discharge amount is reduced. When the oxygen supply regulator is turned anti-clockwise, the oxygen discharge amount may be increased.

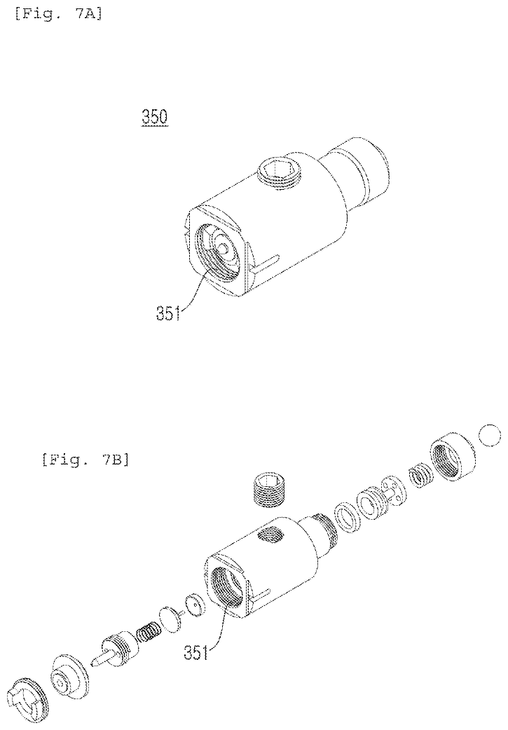

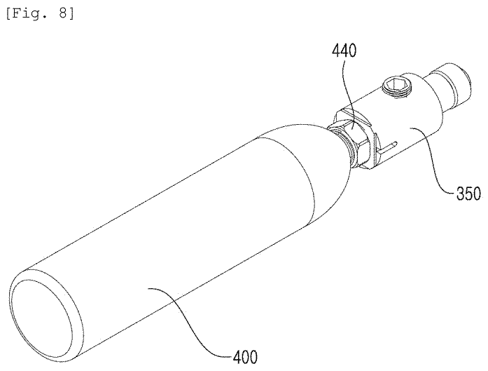

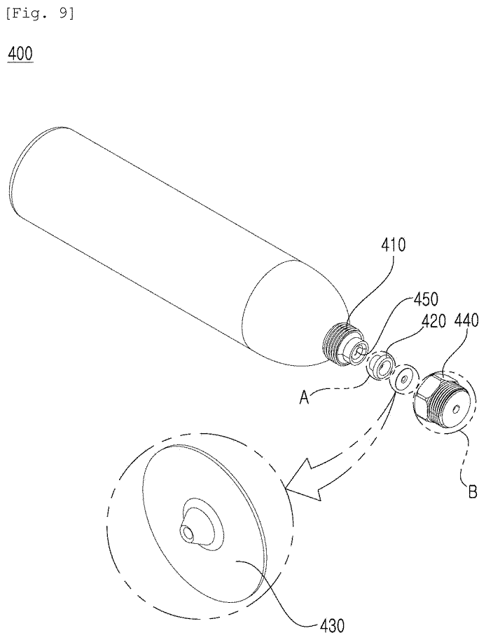

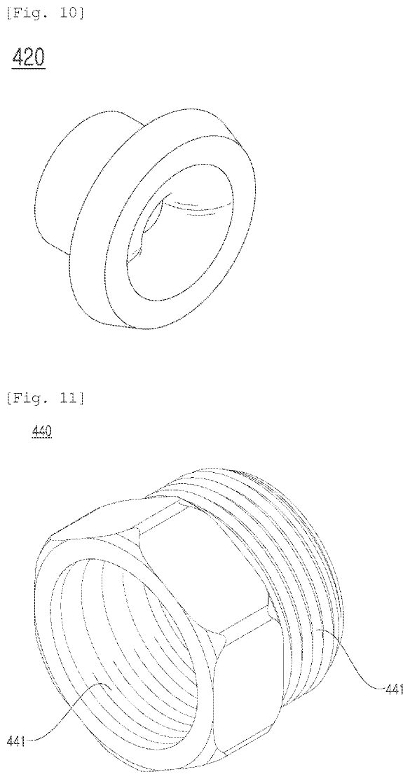

FIGS. 7A and 7B are a perspective view and an exploded perspective view showing the pressure regulator 350 of the portable re-breathing apparatus 900 according to FIG. 7B. FIG. 8 is a perspective view showing the oxygen supply unit 300 of the portable re-breathing apparatus 900 according to the second embodiment of the present disclosure. FIG. 9 is an exploded-perspective view showing the oxygen container 400 according to the second embodiment of the present disclosure. FIG. 10 is an enlarged perspective view showing part A in FIG. 9. FIG. 11 is an enlarged perspective view showing part B in FIG. 9.

The oxygen supply unit 300 may include the pressure regulator 350 reducing the pressure of oxygen discharged from the oxygen container 400. The oxygen container 400 and the pressure regulator 350 are removably coupled to each other, so that a used oxygen container 400 may be replaceable. The oxygen container 400 may include a supply hole 450 formed on an upper portion thereof, the supply hole 450 communicating with the pressure regulator 350; a screw thread part 410 formed on an upper outer circumferential surface of the oxygen container 400, a first cap 420 inserted-coupled to the supply hole 450 and having a hole communicating with the supply hole 450, a second cap 430 coupled to the first cap 420 and having a hole communicating with the supply hole 450, and a screw coupling part 440 having a hole communicating with the supply hole 450 at an upper portion thereof and having screw threads 441 on inner and outer circumferential surfaces thereof. The screw coupling part 440 may be coupled to the screw thread part 410. The pressure regulator 350 may have a screw thread 351 coupled to the screw coupling part 440 on a lower inner circumferential surface thereof. The screw coupling part 440 of the oxygen container 400 may be removably screwed-coupled to the pressure regulator 350. The first cap 420 ma have a shape of which a center portion is convex downward, and be made of an elastic material. The second cap 430 may have a shape of which a center portion is convex downward to correspond to the shape of the first cap 420.

As shown in FIGS. 7A and 7B or 8, the pressure regulator 350 may serve to reduce the pressure of oxygen discharged from the oxygen container 400 in which oxygen is compress-stored. The pressure regulator 350 may be screwed-coupled to the oxygen container 400. As the oxygen container 400 is screwed-coupled to the pressure regulator 350, when all oxygen in the oxygen container 400 is consumed, the user can easily separate the used oxygen container 400 and replace the used oxygen container 400 with a new oxygen container 400.

The pressure regulator 350 may reduce the pressure from 180 bar to 7 bar. As the pressure regulator 350 is directly coupled to the oxygen container 400 storing high-pressure oxygen and regulates oxygen from high pressure to low pressure, there is no need to use expensive devices capable of withstanding high pressure for the hose 15 connecting the pressure regulator 350 to the second oxygen mixing part 200, a device such as the oxygen density regulator 220, etc. that are connected to the portable re-breathing apparatus after pressure reduction. Therefore, general devices may be used for the devices connected to the portable re-breathing apparatus after pressure reduction, so that economic efficiency and convenience of the portable re-breathing apparatus may be improved. When the pressure regulator 350 is coupled to the oxygen container 400, there is no need to use the oxygen container connecting part 320 or a manual valve. Therefore, the weight of the portable re-breathing apparatus so that economic efficiency and convenience of the portable re-breathing apparatus may be improved.

The oxygen container 400 storing compressed oxygen therein supplies oxygen to the second oxygen mixing part 200. The oxygen container 400 may include the screw thread part 410, the first and second caps 420 and 430, the screw coupling part 440, etc.

As shown in FIG. 9, the oxygen container 400 may include the supply hole 450 communicating with the pressure regulator 350 at the upper portion thereof. The screw thread part 410 may be formed on the upper outer circumferential surface of the oxygen container 400.

As shown in FIG. 10, the first cap 420 is inserted-coupled to the supply hole 450, and the first cap 420 may have the hole communicating with the supply hole 450 at a center portion thereof. The first cap 420 has the shape of which the center portion is convex downward, and may be made of an elastic material so as to efficiently maintain air pressure.

The second cap 430 is coupled to the first cap 420. The second cap 430 may have the hole communicating with the holes of the supply hole 450 and the first cap 420 at a center portion. The second cap 430 may have the shape of which the center portion is convex downward to correspond to the shape of the first cap 420.

As shown in FIG. 9 or 10, the screw coupling part 440 includes the hole communicating with the supply hole 450, the holes of the first and second cap 420 and 430 at the center portion thereof. The screw coupling part 440 includes the screw threads on the outer and inner circumferential surfaces thereof, so that the screw coupling part 440 may be coupled to the screw thread part 410. The screw coupling part 440 having the hole with the screw thread 441 on the inner circumferential surface thereof may be inserted into the screw thread part 410, so that the screw thread 441 formed on the inner circumferential surface of the screw coupling part 440 and the screw thread part 410 may be screwed-coupled to each other.

Therefore, the pressure regulator 350 having the hole with the screw thread 351 on the lower inner circumferential surface thereof may be screwed-coupled to the screw thread 441 formed on the outer circumferential surface of the screw coupling part 440.

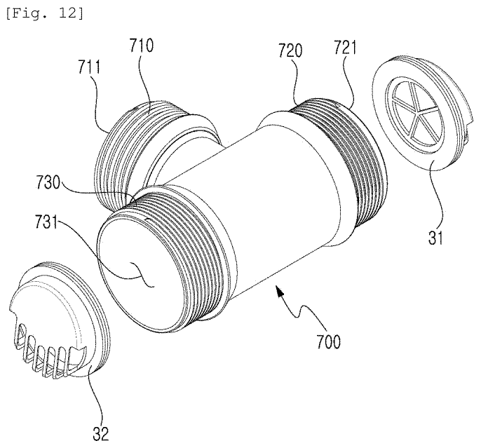

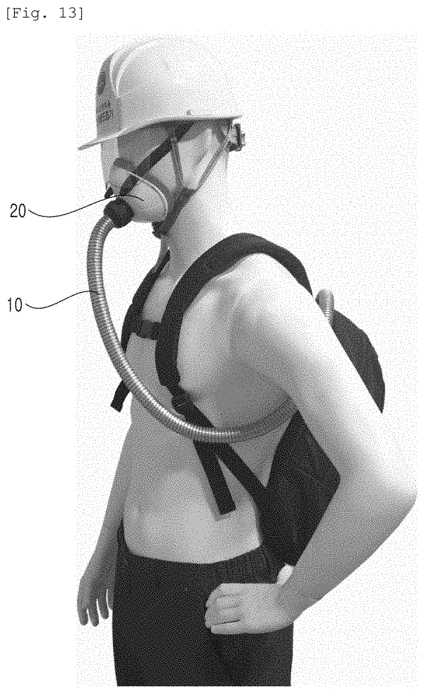

FIG. 12 is a perspective view showing the connector 700 of the portable re-breathing apparatus 900 according to the second embodiment of the present disclosure. FIG. 13 is a view showing an operation of the portable re-breathing apparatus 900 according to the second embodiment of the present disclosure.

The portable re-breathing apparatus 900 may include the T-shaped connector 700 including three holes. The connector 700 may include a first connector 710 having a first hole 711 and coupled to the main hose 10, a second connector 720 having a second hole 721 and coupled to the first oxygen mixing part 100, and a third connector 730 having a third hole 731 and coupled to the second oxygen mixing part 200. The connector 700 may be configured such that the second hole 721 is closed in inhalation and the third hole 731 is closed in exhalation.

As shown in FIG. 5 or 12, the connector 700 may serve to connect the first and second oxygen mixing parts 100 and 200 to the main hose 10, and include the first, second, and third connectors 710, 720, and 730. The connector 700 may have a T-shape including the three holes 711, 721, and 731. The connector 700 is directly connected to the first and second oxygen mixing parts 200 and the single main hose 10 is connected to the mask 20, so that the user can easily and conveniently use the portable re-breathing apparatus.

As shown in FIG. 12 or 13, the first connector 710 may have the first hole 711 and be coupled to the main hose 10 to supply oxygen to the main hose 10. The second connector 720 may have the second hole 721 and be coupled to the first oxygen mixing part 100 to allow the main hose 10 and the first oxygen mixing part 100 to communicate with each other. The third connector 730 may have the third hole 731 and be coupled to the second oxygen mixing part 200 to allow the main hose 10 and the second oxygen mixing part 200 to communicate with each other. The connector 700 may be configured such that the second hole 721 is closed in inhalation to prevent exhalation in the first oxygen mixing part 100 from flowing into the main hose 10, and the third hole 731 is closed in exhalation to prevent the exhalation from flowing into the second oxygen mixing part 200.

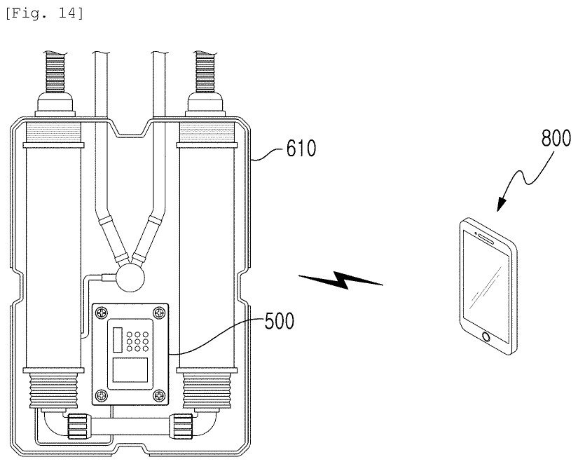

FIG. 14 is a view showing the portable re-breathing apparatus 900 of the present disclosure in conjunction with an external wireless terminal 800.

The controller 500 may be automatically operated by AI operated by a bio-sensor, and include an automatic emergency call function, three information sharing channels, an IoT network wireless communication module, and a high-capacity internal re-chargeable battery.

The controller 500 may be operated by AI operated by the bio-sensor and all functions thereof may be automatically operated by AI. A main circuit board of the controller 500 may include an automatic emergency call function module and three information sharing channel modules, and be equipped with an IoT network wireless communication module, and have a plurality of high-capacity internal re-chargeable batteries.

The external wireless terminal 800 and a smart control program Pr provided in the external wireless terminal 800 may be provided. The external wireless terminal 800 and the smart control program Pr may be connected to the controller 500 through a wireless communication means, and thus allow a safety manager to check the current status of the user and to notify the user of a dangerous situation in advance.

As an example, a smart phone may be used as the external wireless terminal 800, but various external wireless terminals 800 such as a smart watch, a tablet PC, etc. may be applied.

An application of the external wireless terminal 800 is run, then basic information such as the amount of oxygen and CO2 of the portable re-breathing apparatus 900 worn by the user can be checked at all times, and the information can be shared in real time.

As shown in FIG. 14, the manager can monitor and supervise the current status of each of a number of workers by running a monitor mode or an administrator mode, and an alert is immediately sent to a worker in a hazardous situation, for example in a situation with an imminent lack of oxygen, so that the worker can get out of the hazardous situation. For example, a display part is provided on a safety helmet of a worker. Therefore, a co-workers working together can become aware of a hazardous signal, so that the co-workers can take emergency actions.

The present disclosure relates to the portable re-breathing apparatus 900. The portable re-breathing apparatus 900 of the present disclosure is configured, in an emergency situation such as a work site of decommissioning or firefighting, to use closed breathing using exhalation, to increase using time and reduce weight and volume of the portable re-breathing apparatus through easy replacement of an oxygen container 400, to adopt IoT technology so that the manager checks the status of a user in real time, and to enable a safe work by two way communication to improve safety and convenience and economy efficiency of the user.

Even when inflow of outside air is prevented, the portable re-breathing apparatus appropriately mixes oxygen with exhalation generated by breathing to enable a user to breathe. Therefore, spontaneous breathing is possible for a long time, and the safety of the user can be guaranteed in extreme environment and work efficiency can be improved. Oxygen can be supplied to the second oxygen mixing part 200 by using the second oxygen supply regulator 222 even when there is a problem with the electronic control. As the oxygen container 400 is screwed-coupled to the pressure regulator 350, when all oxygen in the oxygen container 400 is consumed, the user can easily separate the used oxygen container 400 and replace the used oxygen container 400 with a new oxygen container 400. As the pressure regulator 350 is directly coupled to the oxygen container 400 storing high-pressure oxygen and regulates oxygen from high pressure to low pressure, there is no need to use expensive devices that can withstand high pressure with respect to the hose connecting the pressure regulator 350 to the second oxygen mixing part 200, a device such as the oxygen density regulator 220, etc. that are connected to the portable re-breathing apparatus after pressure reduction. Therefore, general devices may be used for the devices connected to the portable re-breathing apparatus after pressure reduction, so that economic efficiency and convenience of the present disclosure can be improved. When the pressure regulator 350 is coupled to the oxygen container 400, there is no need to use the oxygen container connecting part 320 or a manual valve. Therefore, the weight of the portable re-breathing apparatus can be reduced so that economic efficiency and convenience of the portable re-breathing apparatus can be improved. The connector 700 is directly connected to the first and second oxygen mixing parts 200 and the single main hose 10 is connected to the mask 20, so that the user can easily and conveniently use the portable re-breathing apparatus.

Although the exemplary embodiments of the present disclosure have been described with reference to the accompanying drawings, the embodiments described in the present specification and configurations shown in the drawings are only the exemplary embodiments of the present disclosure, but do not represent all the technical ideas of the present disclosure. Therefore, it should be understood that there may be various equivalents and modifications that can be substituted for them at the time of filing the present application. Therefore, the embodiments described above are to be understood as illustrative and not restrictive in all respects, and the scope of the present disclosure is indicated by the following claims rather than the detailed description, and the meaning and scope of the claims and all changes or modifications derived from concept equivalent thereto should be construed as being included in the scope of the present disclosure.

### DESCRIPTION OF THE REFERENCE NUMERALS IN THE DRAWINGS

10: main hose
11: inhalation hose
12: exhalation hose
20: mask
30: respirator
50: air movement part
100: first oxygen mixing part
110: sensor
200: second oxygen mixing part
210: filter
220: oxygen density regulator
221: first oxygen supply regulator
222: second oxygen supply regulator
300: oxygen supply unit
310: oxygen supply hose
320: oxygen container connecting part
350: pressure regulator
400: oxygen container
410: screw thread part
420: first cap
430: second cap
440: screw coupling part
450: supply hole
500: controller
610: casing part
620: wearing part
630: storage tank
700: connector
710: first connector
720: second connector
730: third connector
800: external wireless terminal
900: portable re-breathing apparatus

What is claimed is:

1. A portable re-breathing apparatus for a disaster, the portable re-breathing apparatus comprising:
a mask configured to be worn on face of a user to correspond to mouth thereof and connected to a main hose through which air flows;
a first oxygen mixing part connected to the main hose and through which exhalation flows;
a second oxygen mixing part configured to remove carbon dioxide (CO2) in the exhalation and to provide oxygen to the mask through the main hose;
an air movement part connecting the first oxygen mixing part to the second oxygen mixing part;
an oxygen supply unit comprising an oxygen container compress-storing oxygen and configured to supply oxygen to the second oxygen mixing part; and
a controller connected to the first and second oxygen mixing parts and the oxygen supply unit and configured to regulate CO2 and oxygen density to allow the user to breath.

2. The portable re-breathing apparatus of claim 1, wherein an inhalation hose is connected to a first portion of the mask and an exhalation hose is connected to a second portion thereof.

3. The portable re-breathing apparatus of claim 1, wherein the oxygen supply unit comprises:
an oxygen supply hose connected to the second oxygen mixing part; and
an oxygen container connecting part mounted to the oxygen supply hose,
wherein the oxygen container is removably connected to the oxygen container connecting part and configured to be replaceable.

4. The portable re-breathing apparatus of claim 3, further comprising:
a casing part to which the first oxygen mixing part or the second oxygen mixing part is mounted, and configured to be worn on back of the user; and
a wearing part consisting of a strap connected to the casing part and slung on shoulder.

5. The portable re-breathing apparatus of claim 4, wherein the oxygen supply hose comprises a plurality of oxygen supply hoses to be respectively arranged on opposite shoulders,
a storage tank provided in the casing part having inlets divided from the storage tank toward opposite sides, and the oxygen supply hoses are respectively connected to the inlets, and
a hose connected to an outlet of the storage tank is connected to the controller, and is connected to the second oxygen mixing part while passing through the controller.

6. The portable re-breathing apparatus of claim 1, the first oxygen mixing part comprises a sensor configured to detect oxygen, CO2, pressure, and temperature.

7. The portable re-breathing apparatus of claim 1, wherein the second oxygen mixing part comprises a filter configured to remove CO2 and to be replaceable.

8. The portable re-breathing apparatus of claim 1, wherein the second oxygen mixing part comprises an oxygen density regulator configured to regulate density of oxygen supplied from the oxygen supply unit.

9. The portable re-breathing apparatus of claim 8, wherein the oxygen density regulator comprises:
a first oxygen supply regulator configured to oxygen supplied to the second oxygen mixing part by being automatically operated when the controller is operated and power is supplied; and
a second oxygen supply regulator configured to supply oxygen to the second oxygen mixing part by being operated when the first oxygen supply regulator is not operated due to non-operation of the controller or no-supply of power.

10. The portable re-breathing apparatus of claim 1, wherein the oxygen supply unit further comprises a pressure regulator configured to reduce the pressure of oxygen discharged from the oxygen container.

11. The portable re-breathing apparatus of claim 10, wherein the oxygen container and the pressure regulator are removably coupled to each other, so that a used oxygen container is replaceable.

12. The portable re-breathing apparatus of claim 10, wherein the oxygen container comprises:
a supply hole provided at an upper portion of the oxygen container and configured to communicate with the pressure regulator;
a screw thread part located on an upper outer circumferential surface of the oxygen container;
a first cap inserted-coupled to the supply hole and having a hole configured to communicate with the supply hole;
a second cap coupled to the first cap and having a hole configured to communicate with the supply hole; and
a screw coupling part having a hole located on an upper portion thereof and configured to communicate with the supply hole, and having screw threads on inner and outer circumferential surfaces thereof,
wherein the screw coupling part is coupled to the screw thread part.

13. The portable re-breathing apparatus of claim 12, wherein the pressure regulator has a screw thread on a lower inner circumferential surface thereof, the screw thread being coupled to the screw coupling part, and
the screw coupling part of the oxygen container is removably screwed-coupled to the pressure regulator.

14. The portable re-breathing apparatus of claim 12, wherein the first cap has a shape of which a center portion is convex downward, the first cap including an elastic material, and
the second cap has a shape of which a center portion is convex downward to correspond to the shape of the first cap.

15. The portable re-breathing apparatus of claim 1, further comprising:
a T-shaped connector having three holes,
wherein the T-shaped connector comprises:
a first connector having a first hole and coupled to the main hose;
a second connector having a second hole and coupled to the first oxygen mixing part; and
a third connector having a third hole and coupled to the second oxygen mixing part,
wherein the connector is configured such that the second hole is closed during inhalation and the third hole is closed during exhalation.

16. The portable re-breathing apparatus of claim 1, wherein the controller is automatically operated by an artificial intelligence operated by a bio-sensor, and comprises an automatic emergency call function, three information sharing channels, an IoT network wireless communication module, and a high-capacity internal rechargeable battery.
